(19) United States
(12) Patent Application Publication
(10) Pub. No.: US 2021/0192091 A1
(43) Pub. Date: Jun. 24, 2021

(54) SECURE INPUT MODE OF KEYBOARDS

(71) Applicant: HEWLETT-PACKARD DEVELOPMENT COMPANY, L.P., SPRING, TX (US)

(72) Inventors: ALEXANDER WAYNE CLARK, SPRING, TX (US); KENT E BIGGS, SPRING, TX (US); KENNETH CHAN, SPRING, TX (US)

(21) Appl. No.: 16/756,418

(22) PCT Filed: Jan. 31, 2018
(86) PCT No.: PCT/US2018/016178

§ 371 Date: Apr. 15, 2020

(51) Int. Cl. G06F 21/82; G06F 3/023; G06F 21/36

(52) U.S. Cl. CPC G06F 21/82; G06F 21/36; G06F 3/0238

(57) ABSTRACT

Example implementations relate to keyboards. In some examples, a keyboard may comprise a key including a display and a controller. The controller may determine the keyboard in a secure input mode and modify the display of the key in response to the keyboard being in a secure input mode.

### BACKGROUND

A keyboard can be utilized as an input device for an electronic device. For example, a keyboard can be utilized to provide inputs for letters, numbers, and/or other symbols or characters to an electronic device, among other possibilities. Examples of electronic devices having a keyboard can include laptop computers, desktop computers, and/or mobile devices, among other types of electronic devices.

### BRIEF DESCRIPTION OF THE DRAWINGS

FIG. 1 illustrates an example of a secure input mode of a keyboard consistent with the disclosure.

FIG. 2 illustrates an example of keys displaying a corresponding character consistent with the disclosure.

FIG. 3 illustrates an example of a keyboard having keys and a controller consistent with the disclosure.

FIG. 4 illustrates an example of a computing device and a keyboard consistent with the disclosure.

### DETAILED DESCRIPTION

Keyboards can utilize keys to receive key presses from a user. The key presses can correspond to an input for a computing device. As used herein, the term “keyboard” can, for example, refer to a device utilizing an arrangement of buttons (e.g., keys) to input information into a computing device. Utilizing these keys can allow for keyboards to input characters, such as letters, numbers, and/or other symbols via the keys of the keyboard to a computing device. As used herein, the term “key” can, for example, refer to a button control an input to a computing device. As used herein, the term “computing device” can, for example, refer to a laptop computer, a desktop computer, a server, storage and/or networking equipment, among other types of computing devices.

Keyboards may be utilized to input sensitive information into a computing device. For example, a user may input information such as passwords, social security numbers, credit card information, a personal identification number (PIN), and/or other sensitive information. Someone watching a user input this information may be able to determine the sensitive information being input via the keyboard by observing the keys used by the user as the user inputs the sensitive information. For instance, an observer may watch the keys input by a user as the user inputs a password. The observer may be able to determine the password by watching the keys the user presses to input the password.

Secure input mode of keyboards, according to the disclosure, can protect sensitive information as it is input via a keyboard. For example, the characters on the keys of the keyboard can be modified by various character modification techniques in order to stop an observer from observing input of sensitive information via a keyboard. The character modification of keyboard keys may utilize a secure input mode on the keyboard, where passwords and sensitive content can be protected by various ways of hiding the data input to the keyboard via the various ways of character modification.

Security input mode according to the disclosure, can refer to information determined by the type of users who may be directly or indirectly accessing the system, the type of data, including classification levels, compartments, and categories that are processed on the computing device, and the type of levels of users, and formal access approvals that the users may have.

As the keyboard enters a secure input mode, the keyboard can create a secure input mode and modify the characters displayed on the keys based on the security level of the secure input mode. The modification of some keyboard keys may be accomplished through electronic ink (E-ink) display organic light-emitting diode (OLED) display, and/or some other technology. As used herein, the term “modification” can, for example, refer to an act or process of changing a character displayed on a key of the keyboard to display a different character from the original character.

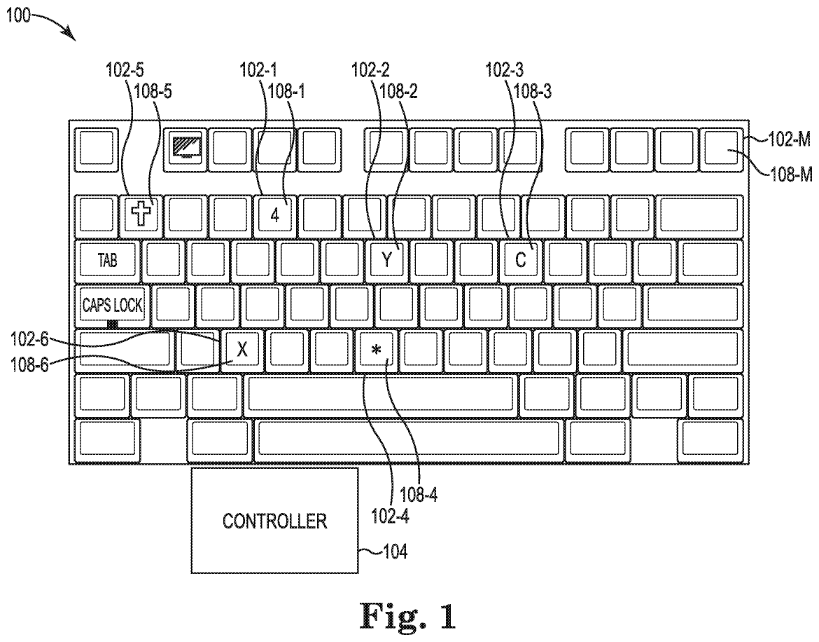

FIG. 1 illustrates an example of a secure input mode of a keyboard 100 consistent with the disclosure. As illustrated in FIG. 1, keyboard 100 can include key 102-1 having display 108-1, key 102-2 having display 108-2, key 102-3 having display 108-3, key 102-4 having display 108-4, key 102-5 having display 108-5, key 102-6 having display 108-6 and key 102-M having display 108-M. Keys 102-1, 102-2, 102-3, 102-4, 102-5, 102-6, 102-M can be referred to collectively herein as keys 102, Similarly, displays 108-1, 108-2, 108-3, 108-4, 108-5, 108-6, 108-M can be referred to collectively herein as displays 108.

In one example, controller 104 can be a chip, an expansion card, or a stand-alone device that interfaces with a peripheral device. This may be a link between two parts of a computing device. As used herein, the term controller can be a device used to control another device and/or a port to receive and send information.

Controller 104 can determine that keyboard 100 is in a secure input mode. For example, controller 104 can determine that keyboard 100 is in a secure input mode either contextually by identifying the information entered in keyboard 100 and/or manually using some other signal.

In one example, controller 104, can determine the type of user expected to access the system by an authentication process, Once authentication is completed, controller 104 may determine that keyboard 100 is in secure input mode.

Controller 104 can modify displays 108 in response to the determination that keyboard 100 is in a secure input mode. For example, based on that determination, controller 104 can modify a display 108 of the keys 102 by randomizing a location of characters associated with each key 102, distorting a font of characters associated with each key 102, adjusting a font size of characters associated with each key 102, adjusting a font contrast of characters associated with each key 102, adjusting an intensity level of a backlight of each display 108, blacking out characters associated with each key 102, changing a character associated with each key 102 to a different symbol, and/or and/or combinations thereof.

In some examples, controller 104 of the keyboard 100 can modify the character displayed on the keys by randomizing a location of a character associated with each key to change the keys layout. Key location randomization can guard against an instance where a rogue observer can watch a user's hands to see keys 102 they press. As used herein, the term “key location randomization” can, for example, refer to randomly labeling keys across the keyboard 100 from a QWERTY layout to a non-QWERTY layout. Key location randomization disallows an outside observer to know the keys being typed in the keyboard. For example, when a key is being pressed by a user, the keyboard registers it as a key press for the labeled key, not what key would normally be in that QWERTY context.

For example, the location of a key associated with the character “L” may be changed from it's location in a QWERTY layout to a different location in a non-QWERTY layout. For instance, the locations of the letters “L” and “R” may be swapped such that a rogue observer may think the user is pressing the letter “R” when the user is actually pressing the letter “L”.

Controller 104 can modify display 108-1 of key 102-1 by randomizing a location of character from a QWERTY layout to a non-QWERTY layout. For example, when a key is being pressed by a user, the keyboard registers it as a key press for the labeled key and displays the key associated with the character, instead of the QWERTY layout. For example, the display of the associated keys L and R may be changed to display R and L instead of the QWERTY layout.

Using key location randomization controller 104 can hide the data input to protect sensitive information. Controller 104 may randomly label keys 102-M across the keyboard 100 in a non-QWERTY fashion via location randomization. As a key 102-1 is being pressed by a user, controller 104 registers it as a key press for the labeled key 102-1, not what key 102-1 would normally be in that QWERTY context.

In some examples, controller of the keyboard can modify the character displayed on the keys by key font distortion. As used herein, the term “key font distortion” can, for example, refer to changing an image from an original version to a misshapen version. Key font distortion, according to the disclosure, can be used to mask the keys with a distorted or misleading image. For instance, the font of the keys may be distorted for added security.

Controller 104 may determine keyboard 100 is in secure input mode and for example, modify display 108-2 of key 102-2 by distorting a font of a character of key 102-2.

For example, controller 104 can distort a character of a key 102-2 displaying a letter, for example the letter X, from the original display to a distorted display. For example, the letter X may be distorted and placed at an angle with uneven lines to make it appear like the letter Y. In this instance, key 102-2 will display 108-2 as a distorted image of the letter X to mislead an unexpected observer.

In some examples, controller of the keyboard can modify the character displayed on the keys by key font size adjustment. As used herein, the term “font” can, for example, refer to a graphical representation of text. As used herein, the term “key font size adjustment” can, for example, refer to adjusting a size of a typeface, point size, weight, color, design and/or adjusting the size of other graphical representations of the text.

For example, controller 104 can cause display 108-1 of key 102-1 to adjust a font size of the character associated with key 102-1. As illustrated in FIG. 1, display 108-1 can display “4” as the character associated with key 102-1. Controller 104 cause display 108-1 to adjust the size of the 4 of key 102-1 smaller, larger, adjust the weight, color and/or other portions of the 4 to adjust the font size. Adjusting font size of a character associated with key 102-2 from font size 12 to size 6, making it more difficult to read from a distance when displayed on display 108-2

In some examples, controller 104 may determine keyboard 100 is in a secure input mode and modify display 108-2 of key 102-2 by adjusting a font text. For example, controller 104 can change the graphical representation of key 102-2 from Arial to Brush Script MT, among other types of font text.

In some examples, controller of the keyboard can modify the character displayed on the keys by key font contrast. As used herein, the term “key font contrast” can, for example, refer to adjusting the background of the key and the font of the key such that the difference in color between the background of the key and the font of the key is very small, making it more difficult for an outside observer to read the key display. For example, controller 104 may determine keyboard 100 is in a secure input mode and, for example, modify display 108-3 of key 102-3 by adjusting a font contrast of a character of key 102-3 such that the color of the character of key 102-3 and the color of the background of key 102-3 are similar. For instance, controller 104 can adjust the background of key 102-3 to blue and the font key 102-3 to indigo thus, making the display hard to read by an outsider. In some examples, keyboard 100 can include red, green; and blue (RGB) light emitting diode (LED) keys 108 that include a backlight. As used herein, the term “backlight”, for example; refers to a form of internal light source to an RGB LED key, used to produce visible image.

Controller 104 may determine keyboard 100 is in secure input mode and for example, change the intensity level of the backlights of keys 102 to make it more difficult to see the display. The term “intensity level” can, for example, refer to the strength and/or sharpness of a color of light that passes through a key surface, perceived by the human eye.

For example; controller 104 can lower the intensity level by dimming the backlight of the keys 102 based on the secure input mode entered by the keyboard.

For example, controller 104 may determine keyboard 100 having RGB LED keys with backlight has entered in a secure input mode. As keyboard 100 enters in a secure input mode, controller 104 may dim the backlight of key 102-4 by reducing the sharpness of RGB LED colors of keyboard 100. As a result, display 108-4 of key 102-4 may be harder to see as less light will pass through the surface of key 102-4.

For example, controller 104 can increase the intensity level by brightening the backlight of the keys 102 based on the secure input mode entered by the keyboard.

For example; as controller 104 determines keyboard 100 is in a secure input mode, controller 104 may brighten the backlight of key 102-4 by increasing the sharpness of RGB LED color. As a result, display 108-4 of key 102-4 may be harder to see as excessive light will pass through the surface of key 102-4.

In some examples, controller 104 may determine keyboard 100 is in a secure input mode and, for example, modify display 108-3 of key 102-3 by blacking out display 108-4 of key 102-4. As used herein, the term “blackout” can, for example, refer to keyboard keys deliberately kept off and/or are kept hidden from displaying characters.

For example, controller 104 may determine keyboard 100 is in a secure input mode and deliberately, for example, blackout key 102-3 by hiding display 108-3.

In some examples, controller 104 may determine keyboard 100 is in a secure input mode and, for example, and modify display 108-3 of key 102-3 by changing a character associated with each key to a different symbol. For example, controller 104 can modify the character of the keys 102 by changing a key 102 from, for instance, an “L” to a symbol. For example, as illustrated in FIG. 1, display 108-5 of key 102-5 can be modified such that display 108-5 displays a cross shape rather than a “1”.

In some examples, controller of the keyboard can modify the character displayed on the keys by modifying the keys to display symbols, instead of letters.

For example, controller 104 can cause display 108-2 of key 102-2 to display a symbol instead of a letter associated with key 102-2. As illustrated in FIG. 1, display 108-2 can display “+” symbol as the character associated with key 102-1 instead of the letter E, for example, of the original display.

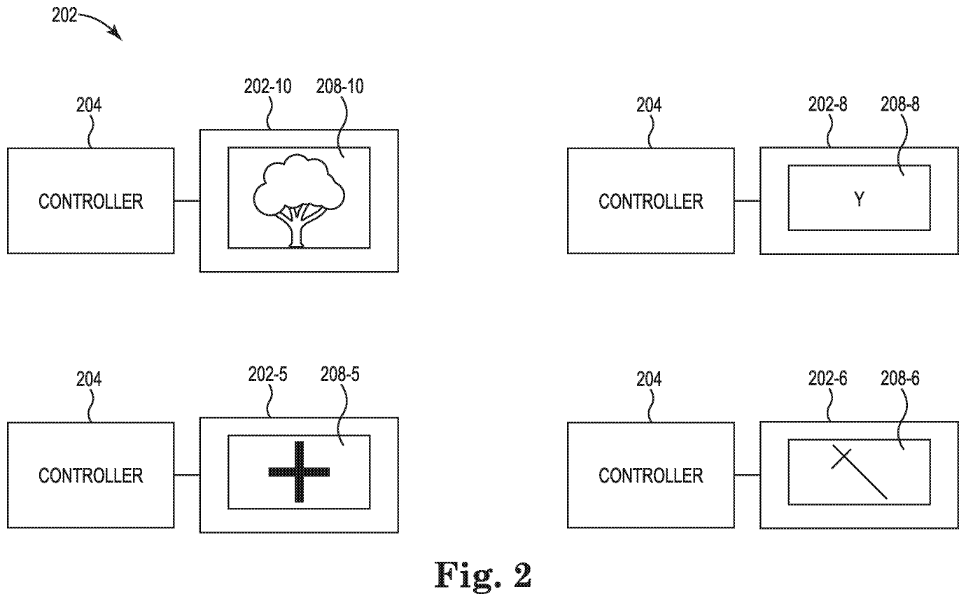

FIG. 2 illustrates an example of keys 202 displaying a corresponding character consistent with the disclosure. As illustrated in FIG. 2, keys 202 can include a corresponding display 208. Controller 204 can be connected to keys 202.

Controller 204 can modify the characters displayed on keys 202 in response to the controller determining the keyboard is in a secure input mode.

Keys 202 can include key 202-2 having display 208-2, and a controller 204 to modify the character displayed on keys 202 as controller 204 determines the keyboard is in the secure input mode. Controller 204 can modify the character of key 202-2 by changing a character associated with each key to a different symbol.

For example, controller 204 may determine the keyboard is in a secure input mode and modify display 208-2 of key 202-2 to display a picture instead of a character. For instance, the picture can be a tree instead of a letter, as illustrated in FIG. 2. However, examples of the disclosure are not limited to the picture being a tree. For example, the picture can be any other symbol (e.g., a cross, a bird, a dog, etc.)

Keys 202 can include key 202-4 having display 208-4, and controller 204 to modify the character displayed on keys 202 as controller 204 determines the keyboard in a secure input mode. Controller 204 can modify the character of key 202-4 by changing a character associated with each key to a different symbol. For example, controller 204 may determine keyboard in a secure input mode and modify the display of key 202-4 to display a symbol, for example a plus symbol, instead of a letter, as illustrated in FIG. 2.

Keys 202 can include key 202-6 having display 208-6, and controller 204 to modify the character displayed on key 202-6 as controller 204 determines keyboard in secure input mode. Controller 204 can modify the character of key 202-6 by adjusting the graphical representation of text that may include a different typeface, point size, weight, color, design and/or other graphical representation. For example, controller 204 may determine keyboard in a secure input mode and modify the display of key 202-6 to display 208-6 in a reduced font size, instead of a standard font size, as illustrated in FIG. 2.

Keys 202 can include key 202-8 having display 208-8, and controller 204 to modify the character displayed on key 202-8 as controller 204 determines the keyboard is in a secure input mode. Controller 204 can modify the character of key 202-8 by masking the keys with a distorted or misleading image. For example, controller 204 may determine the keyboard is in a secure input mode and modify the display of key 202-8 to display 208-8 such that the character “X” is displayed in a distorted manner instead of a clearly marked X, as illustrated in FIG. 2.

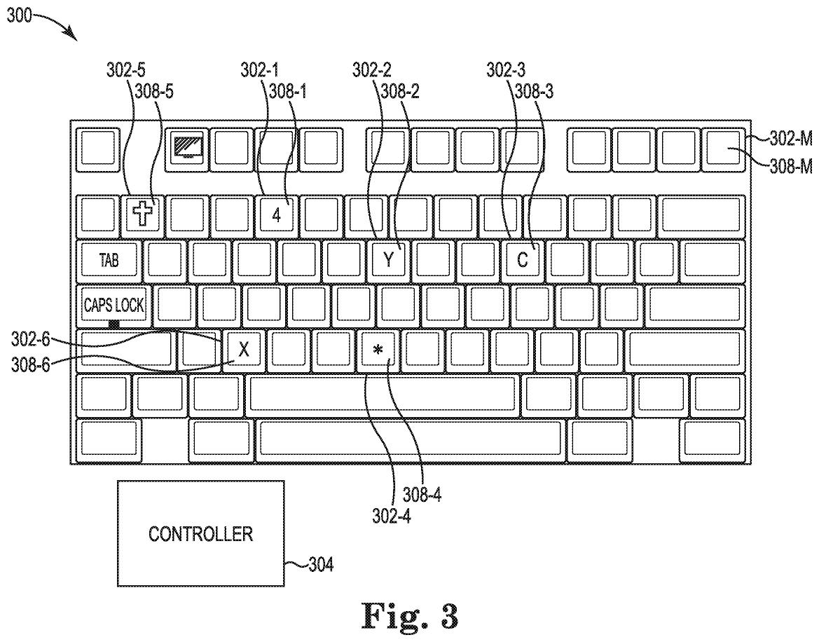

FIG. 3 illustrates an example of a keyboard 300 with keys 302 having displays 308 and controller 304 consistent with the disclosure. As illustrated in FIG. 3, keyboard 300 can include key 302-1 having display 308-1, key 302-2 having display 308-2, key 302-3 having display 308-3, key 302-4 having display 308-4, key 302-5 having display 308-5, key 302-6 having display 308-6 and key 302-M having display 308-M. Keys 302-1, 302-2, 302-3, 302-4, 302-5, 302-6, 302-M can be referred to collectively herein as keys 302. Similarly, displays 308-1, 308-2, 308-3, 308-4, 308-5, 308-6, 308-M can be referred to collectively herein as displays 308.

Controller 304 determines that keyboard 300 is in a secure input mode and modifies the character displayed on the display of the key 302-M using a type of character modification associated with a security level of the secure input mode in response to the keyboard 300 being in the secure input mode. As used herein, the term “security level” can, for example, refer to a value in the policy associated with security content to determine the threshold of required security. For example, a security level can be based on a type of sensitive information being input into keyboard 300. Sensitive information may range, for example, from password to financial data. Security levels can be determined by controller 304 and categorized into tiers of security level.

Controller 304 can determine that keyboard 300 is in a secure input mode by identifying the information entered in keyboard 300. In one example, controller 304, can determine the type of user expected to access the system by an authentication process. Once authentication is completed, controller 304 may determine that keyboard 300 is in secure input mode and modify the characters displayed on display 308-M of key 302-M to stop an observer from observing input of sensitive information via a keyboard.

In one example, if keyboard 300 is not in a secure input mode, controller 304 may determine, for example based on the content being used, that keyboard 300 can enter secure input mode and determine the security level.

As keyboard 300 enters the secure input mode, controller 304 may modify a character displayed on display 308-M of key 302-M using a type of character modification associated with a security level of the secure input mode in response to keyboard 300 being in the secure input mode. For example, the type of character modification can be different based on the security level of the secure input mode, as is further described herein.

A security level of the secure input mode can be assigned based on the sensitivity or secrecy of the information entered in the keyboard. A security level, for example, can include a high level security having a highest degree of protection. One example of a high level security can be a user's social security number, credit card number, PIN number, password, etc. Unauthorized disclosure of such information can result in serious damage to the user.

Controller 304 may determine keyboard 300 in a secure input mode with a high level security. Based on that determination, controller 304 can modify display of the key characters by randomizing a location of character from a QWERTY layout to a non-QWERTY layout, key font distortion, backlight dimming, symbol replacement, and/or other modification techniques to hide the data input to protect sensitive information.

For example, controller 304 may determine keyboard 300 in a secure input mode with a high level security, and modify display 308-2 of key 302-2 by adjusting a font text by changing the graphical representation of key 302-2 from Arial to Brush Script MT-2.

Controller 304 may determine keyboard 300 in a secure input mode with a high level security. Based on that determination, controller 304 can modify display of the key characters displayed on the keys by randomizing a location of key character and changing the keys layout, Key location randomization randomly labels keys across the keyboard in a non-QWERTY fashion.

Controller 304 may determine keyboard 300 in a secure input mode with a high level security and modify display 308-1 of key 302-1 by randomizing a location of character from a QWERTY layout to a non-QWERTY layout. For example, when a key 308-1 is being pressed by a user, the keyboard 300 registers it as a key press for the labeled key and displays the key associated with the character, instead of the QWERTY layout. For example, the display of the associated keys L and R may be changed to display R and L instead of the QWERTY layout.

In one example, controller 304 may determine keyboard 300 in a secure input mode with a high level security. Based on that determination, controller 304 may randomly label keys 302-M across the keyboard 300 in a non-QWERTY fashion. As a key 302-1, for example, is pressed by a user, controller 304 registers it as a key press for modified key 302-1, not what key 302-1 would normally be in that QWERTY context.

Controller 304 may determine keyboard 300 in a secure input mode with a high level security. Based on that determination, controller 304 can modify display 308 of key 302 by blacking out the entire display.

For example, controller 304 may determine keyboard 300 is in a secure input mode with a high level security and deliberately, for example, modify display 308-3 of key 302-3 by blacking out display 308-4 of key 302-4.

In some examples, controller 304 may, based on the security level identified, blackout the entire display 308-6 of key 302-6.

In some examples, a security classification, for example, can include a medium level security having a reasonable degree of protection. Unauthorized disclosure of which is undesirable. One example of a medium level security can be a user's work zip code.

Controller 304 may determine keyboard 300 in a secure input mode with a medium security level. Based on that determination, controller 304 can modify display of the key characters by key location randomization, key font distortion, backlight dimming, symbol replacement, and/or other modification techniques to hide the data input to protect sensitive information.

Controller 304 can may determine keyboard 300 in a secure input mode with a medium security level and modify the character displayed on the keys by key font size adjustment. Font, as used herein, is a graphical representation of text that may include a different typeface, point size, weight, color, design and/or other graphical representation.

For example, controller 304 can determine keyboard 300 in a secure input mode with a medium security level and modify display 308-2 of key 302-2 by adjusting font size on the labels on key 302-2 from size 12 to size 6, making it more difficult to read from a distance when displayed on display 308-2.

Controller 304 may determine keyboard 300 in a secure input mode with a medium security level and modify display 308-2 of key 302-2 by distorting a font of a character of key 302-2. Controller 304 can mask the key 302-2 with a distorted image, for instance, the font of key 302-2 may be distorted, for instance, the font of key 302-2 may be distorted, to modify display 308-2.

Controller 304 may determine keyboard 300 in a secure input mode with a medium security level. Based on that determination, controller 304 can modify the display of the key characters by key font contrast. Key font contrast, according to the current disclosure, is adjusting the background of the key and the font of the key very closely making it more difficult for an outside observer to read.

Controller 304 may determine keyboard 300 in secure input mode with a medium level security and modify display 308-3 of key 302-3 by adjusting a font contrast of a character key 302-3, For instance, controller 304 can very closely adjust the background of key 302-3 to blue and the font key 302-3 to indigo by making the display hard to read by an outsider.

Keyboards can have a red, green, and blue (RGB) light emitting diode (LED) key that includes a backlight, According to the current disclosure, controller 304 can dim the backlight of the keys based on the determination that keyboard 300 is in a secure input mode with a medium level security.

In one example, controller 304 may determine keyboard 300 in secure input mode with a medium security level and modify display 308-4 of key 302-4 by dimming the backlight of key 302-4 according to medium level security.

In some examples, a security classification, for example, can include a low level security having a lesser degree of protection. Unauthorized disclosure of which is undesirable. One example of a low level security can be a user's phone number.

Controller 304 may determine keyboard 300 in a secure input mode with a low level security. Based on that determination, controller 304 can modify display of the character of key 302-6 by adjusting the graphical representation of text that may include a different typeface, point size, weight, color, design and/or other graphical representation.

For example, controller 304 may determine keyboard 300 in a secure input mode with a low level security and modify the display of key 302-6 to display 308-6 in a reduced font size, instead of a standard font size.

Controller 304 may determine keyboard 300 in a secure input mode with a low level security. Based on that determination, controller 304 may modify the character displayed on the keys by modifying the keys to display symbols, for example, instead of letters.

For example, controller 304 determine keyboard 300 in a secure input mode with a low level security and modify the display 308-2 of key 302-2 to display a symbol character instead of a letter associated with key 302-2. As illustrated in FIG. 3, display 308-2 can display “+” symbol as the character associated with key 302-1 instead of the letter E, for example, of the original display.

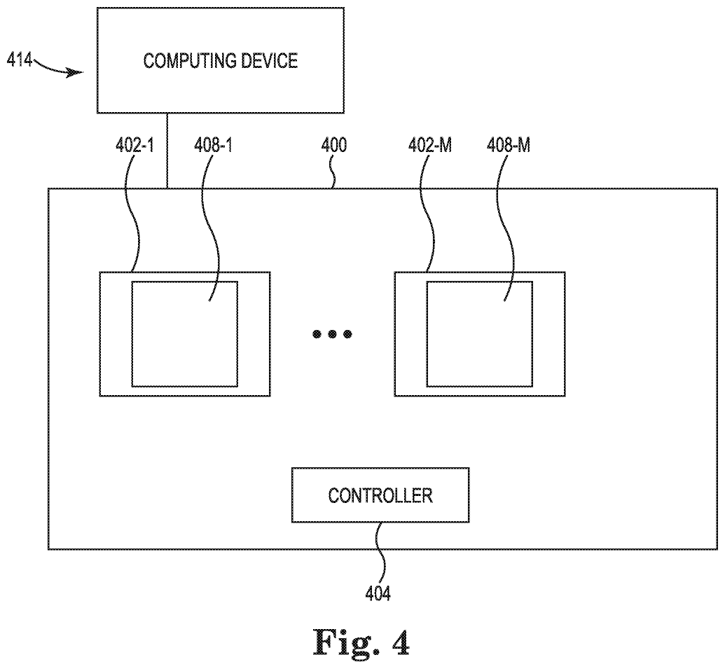

FIG. 4 illustrates an example of a computing device 414 and a keyboard 400, consistent with the disclosure. As illustrated in FIG. 4, computing device 414 can be connected with keyboard 400. Keyboard 400 can include key 402-1 having display 408-1, to key 402-M having display 408-M. Keys 402-1 to 402-M can display characters such symbols, numbers, special characters, neon characters, rainbow characters, non-Latin alphabet, and characters the like.

Computing device 414 can generate signal indicating keyboard 400 is in secure input mode based on security level determined by controller 404. As illustrated in FIG. 4, keyboard 400 can include keys 402-1 to 402-M and a controller 404. Controller 404 can receive a signal indicating keyboard 400 is in a secure input mode. The signal received by controller 404 may include a security level of the secure input mode. Controller 404 can determine the security level for the secure input mode based on the received signal.

Controller 404 may modify the display, for example 408-M, of key 402-M, of the keyboard 400 using character modification techniques based on the security level of the secure input mode. For example, controller 404 may modify the character displayed on 408-1 of key 402-1 to represent a symbol, instead of a letter based on level of security input received computing device 414.

For example, controller 404 may receive a high security level, medium security level, and/or a low level security. Controller 404 can modify the character displayed on key 402-M based on the security level determined by computing device 414. For example, if controller 404 receives a medium level security input from computing device 414, it may modify display 408-M of key 402-M to make the font smaller. In another example, if controller 404 receives a high security input from computing device 414, it may modify display 408-M of key 402-M to distort the font by masking key 402-3 with a distorted image.

In one example, controller 404 can modify display 408-M of key 402-M by randomizing a location of the characters associated with key 402-M.

In one instance, controller 404 can modify display 408-M of key 402-M by distorting a font of the characters associated with key 402-M.

In one example, controller 404 can modify display 408-M of key 402-M by adjusting a font size of the characters associated with key 402-M.

In one instance, controller 404 can modify display 408-M of key 402-M by adjusting a font contrast of the characters associated with key 402-M.

In one example, controller 404 can modify display 408-M of key 402-M by adjusting an intensity level of a backlight of display 408-M

In one instance, controller 404 can modify display 408-M of key 402-M by blacking out the characters associated with key 402-M.

In one instance, controller 404 can modify display 408-M of key 402-M by changing a character associated with key 402-M to a different symbol.

Controller 404 of computing device 414 can remove the character modification of key 402-M in response to keyboard 400 exiting the secure input mode. For example, as a user terminates his secured activity, for example logging out, keyboard 400 may exit secure input mode. As keyboard 400 exits secure input mode, controller 404 can remove character modification from keys 408-1 to 408-M. For example, controller 404 can remove the character modification from keys 402 such that the displays 408 of keys 402 display the original characters on displays 408 in, for instance, a QWERTY layout.

The figures herein follow a numbering convention in which the first digit corresponds to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2. Elements shown in the various figures herein can be added, exchanged, and/or eliminated so as to provide a plurality of additional examples of the disclosure. In addition, the proportion and the relative scale of the elements provided in the figures are intended to illustrate the examples of the disclosure, and should not be taken in a limiting sense. Further, as used herein, “a plurality of” an element and/or feature can refer to more than one of such elements and/or features.

What is claimed:

1. A keyboard, comprising:
a key including a display:
a controller to:
determine whether the keyboard is in a secure input mode; and
modify the display in response to the keyboard being in the secure input mode.

2. The keyboard of claim 1, wherein the controller is to modify the display by randomizing a location of a character from a QWERTY layout to a non-QWERTY layout.

3. The keyboard of claim 1, wherein the controller is to modify the display by distorting a font of a character of the key.

4. The keyboard of claim 1, wherein the controller is to modify the display by adjusting a font size of a character the key.

5. The keyboard of claim 1, wherein the controller is to modify the display by adjusting a font contrast of a character the key.

6. The keyboard of claim 1, wherein the key is a red, green, and blue (RGB) light emitting diode (LED) key that includes a backlight;

7. The keyboard of claim 6, wherein the controller is to modify the display by dimming the backlight of the RGB LED key.

8. The keyboard of claim 1, wherein the controller is to modify the display by blacking-out the display of the key.

9. The keyboard of claim 1, wherein the controller is to modify the display by changing a character associated with the key to a different symbol.

10. A keyboard, comprising:
a key including a display to display a character corresponding the key;
a controller to;
determine whether the keyboard is in a secure input mode; and
modify the character displayed on the display of the key using a type of character modification associated with a security level of the secure input mode in response to the keyboard being in the secure input mode.

11. The keyboard of claim 10, wherein:
the display is an electronic ink (E-ink) display; and
the controller is to modify the character displayed on the display by modifying the E-ink display.

12. The keyboard of claim 10, wherein:
the display is an organic light-emitting diode (OLED) display; and
the controller is to modify the character displayed on the display by modifying the OLED display.

13. A computing device comprising:
a keyboard, including:
a key including a display to display a character; and
a controller to:
receive a signal indicating the keyboard is in a secure input mode, wherein the signal includes a security level of the secure input mode;
determine the security level based on the received signal; and
modify the display of the key of the keyboard using a type of character modification based on the security level of the secure input mode;
wherein the computing device generates the signal indicating the secure input mode.

14. The computing device of claim 13, wherein the controller is to modify the display using a type of character modification from a group consisting of:
randomizing a location of the characters associated with each key;
distorting a font of the characters associated with each key;
adjusting a font size of the characters associated with each key;
adjusting a font contrast of the characters associated with each key;
adjusting an intensity level of a backlight of each display;
blacking out the characters associated with each key;
changing a character associated with each key to a different symbol; and
combinations thereof.

15. The computing device of claim 13, wherein the controller is to remove the character modification of the key in response to the keyboard exiting the secure input mode.
